(19) United States
(12) Patent Application Publication
(10) Pub. No.: US 2025/0032223 A1
(43) Pub. Date: Jan. 30, 2025

(54) ORTHODONTIC ALIGNER WITH ELASTOMERIC INNER SURFACE AND RIGID OUTER SURFACE, AND METHODS OF ORTHODONTIC TREATMENT WITH SAME

(71) Applicant: Ariana LEWKOWITZ-SHPUNTOFF, Roslyn, NY (US)

(72) Inventor: Ariana LEWKOWITZ-SHPUNTOFF, Roslyn, NY (US)

(21) Appl. No.: 18/912,763

(22) Filed: Oct. 11, 2024

Related U.S. Application Data
(63) Continuation-in-part of application No. PCT/IL2023/050394, filed on Apr. 13, 2023.
(60) Provisional application No. 63/330,356, filed on Apr. 13, 2022.

(51) Int. Cl. A61C 7/08; A61C 8/00

(52) U.S. Cl. CPC A61C 7/08; A61C 8/0096

(57) ABSTRACT

An orthodontic aligner includes an inner functional layer comprised of an elastomer and a non-elastomeric outer functional layer. The outer layer may be a biocompatible rigid or semi-rigid polymer. The inner layer may include inner cavities each shaped to receive therein a tooth attachment, such as a lingual tooth attachment. The rigid outer functional layer is sufficiently strong and heat-resistant to withstand the forces and temperatures of eating. The rigid outer layer also provides sufficient lateral force to work on teeth even using lingual or palatal attachments, and to perform orthodontic treatments that are unavailable with elastomeric aligners. A system for orthodontic treatment may include the aligner and tooth attachments, metal rings or snap buttons, magnets, a temporary grill, or at least one chain for raising and exposing an impacted tooth. The orthodontic aligners may be used in various orthodontic treatments, including sequential distalization and raising of an impacted tooth.

### RELATED APPLICATIONS

This application is a Continuation-in-Part of PCT Application No. PCT/IL2023/050394, filed Apr. 13, 2023, entitled “Orthodontic Aligner with Elastomeric Inner Surface and Rigid Outer Surface, and Methods of Orthodontic Treatment With Same,” which claims the benefit of priority of U.S. Provisional Application No. 63/330,356, filed Apr. 13, 2022, entitled “Multilayer Orthodontic Aligner with Elastomeric Inner Layer and Rigid Outer Layer and Methods of Orthodontic Treatment with Same,” the contents of each of which are incorporated by reference as if fully set forth herein.

### FIELD OF THE INVENTION

The present Application relates to the fields of orthodontics, implant dentistry, cosmetic dentistry, and dentofacial orthopedics, and more specifically, but not exclusively, to an orthodontic aligner with an elastomeric inner functional layer and a rigid outer functional layer, and to methods of orthodontic treatment using the orthodontic aligner.

### BACKGROUND OF THE INVENTION

Orthodontic and dental treatments generally have two objectives: functional and cosmetic. Functionally, an orthodontic treatment corrects the orientation of teeth and the shape of a bite. Cosmetically, orthodontic treatments smooth out variations in appearances of the teeth and straighten a patient's smile.

These goals are not always achievable at the same time. Certain orthodontic treatments are highly effective but, at least temporarily, are aesthetically distasteful. Still other dental treatments achieve cosmetic improvements but do not assist at all with respect to functional improvements. An example in the first category is metal braces, while an example in the second category is veneers.

Clear aligners are a relatively recent addition to orthodontic treatments that achieve functional benefits while also being a cosmetic improvement compared to metal braces. Clear aligners are molded of thermoplastic polyurethane and are typically designed to fit over attachments, also known as buttons, which are bonded to the labial and buccal surfaces of the teeth. The force of the aligner acting on the attachments causes the teeth to move. Clear aligners are available today under the trademarks Invisalign® by Align Technologies and Clarity® by 3M, among others.

Despite their recent popularity, clear aligners suffer from significant limitations that hamper their utility and effectiveness.

First, clear aligners are unable to be worn during eating, because the elastomeric material cannot withstand the forces of chewing and the temperature ranges of foods. In addition, food may cause the aligners to stain. As a result, it is necessary to remove and store the aligner during eating.

Second, most clear aligners are currently implemented with attachments on the labial and buccal surfaces of the teeth. Attaching on the labial and buccal surface is necessary because, due to the angulation of the teeth and the limitations of the strength of the elastomer, the clear aligner is unable to apply sufficient force on attachments connected to the lingual surface of the teeth. Also, attachments are necessary for vertical extrusion of teeth. Labial attachments are aesthetically displeasing, and, especially in combination with the frequent removal of the aligner as discussed above, may cause embarrassment to the patient.

Third, clear aligners are currently unable to effectively address certain cosmetic challenges. For example, when a patient is missing a tooth, the solution that is available with clear aligners is to include a pontic. A pontic is a tooth-shaped place holder, created in the space left by a missing tooth in the aligner. However, when the aligner is removed (e.g., for eating), the pontic must be removed with it. Similarly, aligners are unable to effectively compensate for developing depths, thicknesses, or spaces in the dentition. At best, at specific points, the aligner may be constructed with a tooth cavity in the tray being marginally wider, to allow space for a temporary bonding veneer to be applied to a particular tooth. This solution, however, is still subject to the orthodontist's incremental adjustment of the teeth, and comes at the expense of undesirable aesthetics between visits.

Still another cosmetic drawback of clear aligners is their ability to become stained. For example, if a patient smokes, or eats turmeric, the aligners will stain and pick up fragments that highlight the architecture of the various appliances and attachments. Also, if the teeth are stained, the stain will show through the aligners.

Clear aligners are also unable to achieve certain functional objectives, even in combination with other treatments. First, in general, if the force exerted by the clear aligner is not strong enough to move the tooth, the plastic material of the aligner becomes misshapen and deforms outward, leading to patient discomfort and lack of effective movements. Furthermore, forces of clear aligners are limited to horizontal and angular movements, without labial and buccal attachments for lateral force. In addition, clear aligners are not able to achieve certain specific treatments. For example, should a patient have a bimaxillary protrusion, the ideal form of treatment, although least common, is to perform sequential distalization of the molars. The sequential distalization moves the molars distally which makes space for the protruding teeth to be brought back in alignment with the others. However, the material of elastomeric aligners is too soft to properly track the teeth with enough force to distalize the molars and bicuspids in sequence. As a result, if clear aligners are used, the most prevalent treatment of bimaxillary protrusion is to remove healthy teeth that are closest to the deformity. Removing healthy teeth is obviously a suboptimal outcome.

As another example, a patient may have occlusions between teeth as well as a class 3 malocclusion or an asymmetry of the mandible and maxilla arches. The appropriate treatment for severe asymmetry is orthognathic surgery; however, it is also necessary to perform an orthodontic treatment prior to surgery, so that the teeth will be decompensated so that they will meet properly following the surgery. Removable aligners are unable to be used for filling in such occlusion-related gaps after decompensation, prior to surgery.

As still another example, should a patient have TMJ (temporomandibular joint) pain due to mild mandible/maxilla asymmetry, malocclusions, or various forms of arthritis, the patient may be given a special removable appliance that accommodates the angulation of the jaw, or fills in the occlusal gaps. However, this removable appliance cannot simultaneously move teeth into ideal position, and also the patient cannot eat while wearing the removable appliance. Accordingly, the patient may have bite blocks implemented with a composite material to resurface the tooth's height and shape, thereby improving the occlusion at the ideal mandibular/maxillary position. However, adjusting bite blocks while wearing clear aligners is nearly impossible, because the aligners are fitted to the pre-measured shape of the teeth.

Aligners made of ceramic and other rigid materials have been proposed. However, if the ceramic is solid, there will necessarily be an unfilled cavity around the plurality of the teeth. This unfilled cavity may allow entry of food particles. Flexible ceramics do exist but either have a cloth-like structure, which is too soft for orthodontic treatment, or they are flexible in their green state, which may leach chemicals.

### SUMMARY OF THE INVENTION

It is an object of the present disclosure to provide an alternative to a clear aligner that is capable of overcoming the above-described challenges. Specifically, it is an object of the present disclosure to provide an aligner that is capable of being worn while eating. It is a further option of the present disclosure to provide an aligner that does not require the use of labial attachments for movements that would require the use of labial attachments in other types of aligner devices. It is a further object of the present disclosure to provide an aligner that is able to effectively address aesthetic challenges such as missing teeth, or uneven teeth, or impacted teeth, even as the treatment is being performed with the aligner. It is a further object of the present disclosure to provide an aligner that is capable of being used in conjunction with various orthodontic, dental, orthognathic, and other treatments which are currently unavailable with clear aligners.

The present disclosure introduces a new paradigm for the construction of aligners. The aligners are made of a structure having multiple functional layers, with the inner functional layer being elastomeric and the outer functional layer being rigid. The rigid outer functional layer is sufficiently strong and heat-resistant to withstand the forces and temperatures of eating. The rigid outer functional layer also provides sufficient lateral force to work on teeth even using lingual or palatal attachments, and to perform orthodontic treatments that are unavailable with elastomeric aligners. The rigid outer functional layer may either end at the gingival line or may extend over the labial side of the maxilla or over the palate and other medical devices configured at the palate, depending on the desired treatment goals.

The present disclosure further discloses various forms of orthodontic treatment that may be achieved with the orthodontic aligners described herein.

According to a first aspect, an orthodontic aligner includes an inner functional layer comprised of an elastomer, and a non-elastomeric outer functional layer.

In another implementation according to the first aspect, the outer layer is comprised of a biocompatible rigid or semi-rigid polymer.

In another implementation according to the first aspect, the inner functional layer and outer functional layer are made of a functionally graded material. Optionally, the functionally graded material is a functionally graded polymer having greater elasticity at the inner functional layer and greater rigidity at the outer functional layer.

In another implementation according to the first aspect, the aligner further includes a plurality of inner cavities within the inner layer, each inner cavity shaped to receive therein a tooth attachment. Optionally, the inner cavities are configured to receive therein lingual tooth attachments.

In another implementation according to the first aspect, the elastomeric inner functional layer is molded to fit a tooth with sufficient tightness to function as a gasket preventing entry of food particles between the tooth and the orthodontic aligner.

In another implementation according to the first aspect, a combined thickness of the outer and inner functional layers is up to 800 μm in a region surrounding at least one tooth.

In another implementation according to the first aspect, a thickness of the outer layer in said region is approximately 100 microns at a region corresponding to a root of a tooth, and up to approximately 500 microns at a region corresponding to a tip of the tooth, and a thickness of the inner layer is between approximately 300 to 400 microns at the root, and between approximately 50 to 100 microns at the tip. Generally, the thickness of the layers in different regions depends on the material that is used, as well as aesthetic considerations. Thus, when desired for aesthetic purposes, the thickness of the outer layer may be even greater than 500 microns at the tip.

In another implementation according to the first aspect, the aligner maintains structural integrity at temperatures of between approximately −3° C. to 105° C.

In another implementation according to the first aspect, the aligner maintains structural integrity at pressures of up to approximately 800 psi. In particular, the rigid outer functional layer maintains structural integrity at typical pressures of chewing, e.g., up to at least about 160 psi. Preferably, the rigid outer functional layer maintains structural integrity at even greater pressures, such as 700-800 psi, which are pressures that are typical for dentures and crowns.

In another implementation according to the first aspect, the aligner includes at least one region of increased thickness on an external face of the outer functional layer, said region of increased thickness corresponding to a region of decreased thickness of a corresponding tooth or arch point. Optionally, the region of increased thickness has a thickness of up to approximately 8,000 μm, or even greater, if desired for aesthetic purposes.

In another implementation according to the first aspect, the aligner includes at least one pontic, and the pontic is comprised of a material of the outer functional layer over an entire dimension of the pontic and includes the material of the inner functional layer at a gingival margin.

In another implementation according to the first aspect, the aligner further includes an extended portion configured to extend over a hard palate of a patient, said extended portion comprised of the material of the outer functional layer, the material of the inner functional layer, a semi-flexible acrylic, or a hard acrylic.

In another implementation according to the first aspect, the outer layer is comprised of regions having various thicknesses so as to form a veneer and thereby smooth out an appearance of adjacent teeth. Optionally, the regions of various thicknesses include at least one of additional thickness at the tip of a tooth and additional thickness in an interproximal space between two teeth.

In another implementation according to the first aspect, a system for orthodontic treatment includes the orthodontic aligner and one or more aligner attachments configured for attachment onto a patient's teeth.

Optionally, the system further includes metal rings or snap buttons for affixation onto molars. Optionally, the system further includes a plurality of magnets, including a first set of magnets for affixation onto teeth and a second set of magnets for affixation onto the aligner. Optionally, the system further includes a temporary grill applied over the outer functional layer. Optionally, the system further includes at least one chain for raising and exposing an impacted tooth.

According to a second aspect, a method of orthodontic treatment is disclosed. The method includes: applying aligner attachments to a plurality of teeth; and affixing an orthodontic aligner to the teeth, said orthodontic aligner including an inner functional layer comprised of an elastomer; a non-elastomeric outer functional layer, and a plurality of inner cavities within the inner layer, each inner cavity shaped to receive therein an aligner attachment, and the affixing step comprises overlaying the inner cavities over the aligner attachments.

In another implementation according to the second aspect, the orthodontic aligner includes a plurality of inner cavities within the inner layer, each inner cavity shaped to receive therein an aligner attachment, and the method further comprises applying aligner attachments to a plurality of teeth; and the affixing step comprises overlaying the inner cavities over the aligner attachments. Optionally, the step of applying aligner attachments comprises applying the attachments to a lingual side of the teeth.

In another implementation according to the second aspect, the orthodontic aligner comprises at least one interproximal section, said interproximal section being configured to apply an interproximal force, and the method further comprises performing distalization with the at least one interproximal section.

In another implementation according to the second aspect, the method further includes performing sequential molar distalization with a series of orthodontic aligners each having different sections of increased thickness.

Optionally, the at least one interproximal section of a first aligner of the series is comprised of the elastomeric functional layer functioning as a spacer, and the at least one interproximal section of a subsequent aligner of the series is comprised of material of the both the elastomeric functional layer and the outer functional layer.

In another implementation according to the second aspect, the orthodontic aligner further comprises a chain, and the method further comprises affixing the chain to an impacted tooth and raising the impacted tooth to a space opened through the performance of the distalization.

In another implementation according to the second aspect, the step of affixing the orthodontic aligner to the teeth comprises first affixing the inner functional layer and subsequently overlaying the outer functional layer onto the inner functional layer.

In another implementation according to the second aspect, the step of affixing the orthodontic aligner to the teeth comprises affixing the aligner to the teeth when the outer functional layer is already adhered to the inner functional layer.

### BRIEF DESCRIPTION OF THE DRAWINGS

FIG. 1A is an upper perspective view of a multilayer orthodontic aligner, according to embodiments of the present disclosure;

FIG. 1B is a lower perspective view of a multilayer orthodontic aligner, according to embodiments of the present disclosure;

FIG. 1C is a cross-section view of a multilayer orthodontic aligner, according to embodiments of the present disclosure;

FIGS. 2A-2G illustrate the multilayer orthodontic aligner of FIGS. 1A and 1B with different sections built differently based on the state of different teeth, according to embodiments of the present disclosure;

FIGS. 3A-3C illustrate placement of a lingual attachment and a cross section of the aligner in a region corresponding to the lingual attachment, according to embodiments of the present disclosure;

FIG. 4 illustrates the multilayer aligner being overlaid on teeth in order to create an aesthetically pleasing veneer, according to embodiments of the present disclosure;

FIGS. 5A-5D illustrate stages of distalization using the multilayer aligner, according to embodiments of the present disclosure;

FIGS. 6A-6J illustrate stages of sequential distalization using a series of aligners in order to treat bimaxillary protrusion, according to embodiments of the present disclosure;

FIG. 7A illustrates use of the aligner to even the appearance of a tooth that is erupted in the lingual direction, according to embodiments of the present disclosure;

FIGS. 7B and 7C illustrate use of the aligner to even the appearance of a row of teeth including an erupted tooth in the labial direction, according to embodiments of the present disclosure;

FIG. 8 illustrates how the aligner may be used to generate an appearance at the outset of treatment that is equivalent to the end of treatment appearance of the mouth, according to embodiments of the present disclosure;

FIG. 9 illustrates how the aligner may be used for bite correction treatment, according to embodiments of the present disclosure;

FIG. 10 illustrates how the aligner may be used in conjunction with implant treatment, according to embodiments of the present disclosure; and

FIGS. 11A-11H illustrate the use of the aligner to correct an impacted or unerupted tooth, according to embodiments of the present disclosure.

### DETAILED DESCRIPTION OF THE INVENTION

The present Application relates to the fields of orthodontics, implant dentistry, cosmetic dentistry, and dentofacial orthopedics, and more specifically, but not exclusively, to an orthodontic aligner with an elastomeric inner functional layer and a rigid outer functional layer, and to methods of orthodontic treatment using the orthodontic aligner.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the term “layer” refers to a contiguous section of a particular material. The term “functional layer” refers to a contiguous section of a particular material that has similar properties, e.g., with respect to modulus of elasticity, density, hardness, etc. A layer may have more than one functional layer. For example, the layer may be a functionally graded material. The term “functionally graded material” refers to a composite material whose physical properties vary in composition and structure over different depths. A functionally graded multi-material is a functionally graded material made of different materials.

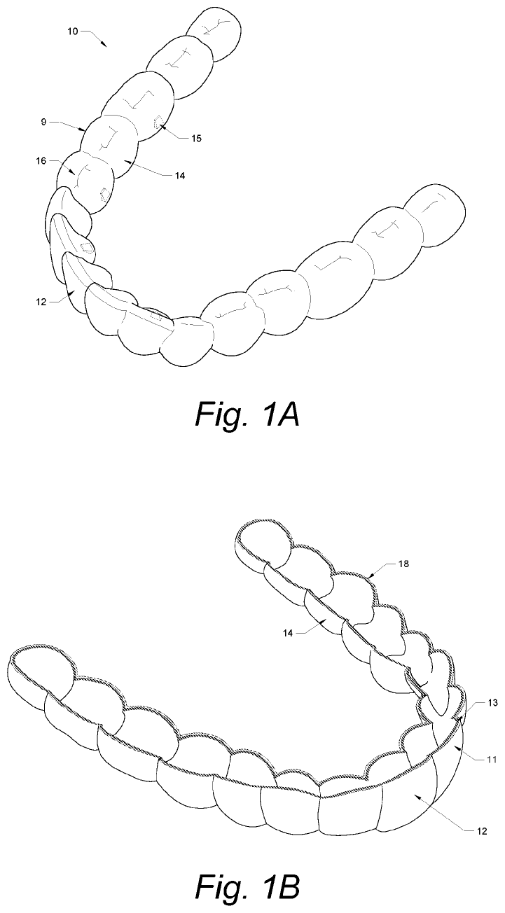

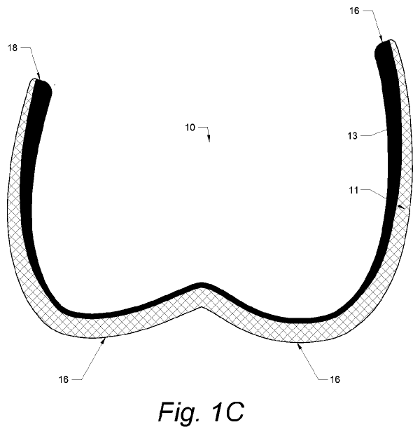

Referring to FIGS. 1A and 1B, aligner 10 is comprised of rigid outer functional layer 11 and elastomeric inner functional layer 13. The outer functional layer 11 and inner functional layer 13 may be made of two different materials. For example, the outer functional layer 11 may be a ceramic or a semi-rigid polymer and the inner functional layer 13 may be an elastomer. In addition or in the alternative, the outer functional layer 11 and inner functional layer 13 may be made of a single, functionally-graded material (e.g., a polymer) or a functionally-graded multi-material. For example, the functionally graded material may be a functionally graded biocompatible polymer having a higher elasticity at the inner layer and a higher rigidity at the outer layer. Although, for purposes of illustration, the layers 11 and 13 are depicted as being of two separate materials, with a clear dividing line between them, this is merely for purposes of illustration, and it is equally possible for the demarcation between the two functional layers to be on a gradient.

The rigid outer functional layer 11 may be a layer made of any suitably rigid and biologically safe material. Exemplary biocompatible materials are a rigid ceramic, porcelain, zirconia, carbon fiber, polymethyl acrylate, polymethyl methacrylate, a rigid polymer, a semi-rigid polymer, a multilayer rigid film, resins, and other polymers currently used in 3D-printed dentures. These materials are desirable due to their heat resistance, force tolerance, strength, and luminosity. The outer layer may also be a flexible ceramic (which may still be more rigid than the elastomer), provided that the flexible ceramic is medically and food grade safe.

Outer functional layer 11 may be made of any desired color. In particular, the color of outer functional layer 11 may be selected from a spectrum of hues in order to approximate the natural look of a tooth, or a naturally stained tooth, per cosmetic indication of the patient.

The elastomeric inner functional layer 13 may be made of any elastomer that is currently used, or that may become used, in the production of clear aligners. Examples of such elastomers include: a polyurethane resin plastic, which is currently used in clear aligners, a silicone rubber, or another form of thermoplastic elastomer.

Both the rigid outer functional layer 11 and the elastomeric inner functional layer 13 are compatible with being worn while eaten. In particular, the rigid outer functional layer maintains structural integrity at typical pressures of chewing, e.g., up to at least about 160 psi. Preferably, the rigid outer functional layer maintains structural integrity at even greater pressures, such as 700-800 psi, which are pressures that are typical for dentures and crowns. The rigid outer functional layer thus compensates for the structural deficiencies of the elastomeric inner functional layer. Both the outer functional layer 11 and inner functional layer 13 maintain structural integrity at temperatures in which food and drink are commonly ingested, or even higher or lower, e.g., from approximately −3° C. to 105° C. The heat tolerance above 100° C. also enables the use of boiling water for cleaning the aligners, as well as prevents damage to the aligners in the event that a user attempts to ingest food or drink that is too hot.

The aligner 10 has a labial side 12, a buccal side 9, a lingual or palatal side 14, an occlusal side 16, and a gingival side 18 at the point of contact with the gum line. Henceforth in this disclosure, the term “labial” will be used to refer to all fixtures on the side of teeth facing the lips, the term “lingual” will be used to all fixtures on the side of teeth facing the tongue, and the term “occlusal” will be used to refer to all surfaces of the teeth facing opposing teeth. On the lingual side 14, the aligner 10 includes a plurality of cavities that accommodate the contours of aligner attachments 15. Aligner attachments 15 are also referred to herein as buttons. The attachments 15 are used to rotate and extrude the tooth, as well as to help anchor the aligner 10 to the tooth. The attachments 15 may be either pre-manufactured and directly applied via a template tray, or directly fabricated via composite and light cure.

FIG. 1C illustrates a cross-section of multilayer aligner 10, and in particular shows the differences in relative thickness of the rigid outer functional layer 11 and elastomeric inner functional layer 13. Generally, the total thickness of the multilayer aligner is up to approximately 550 μm (unless cosmetically indicated for additional thickness). This thickness is consistent with the typical thickness of clear aligners that are presently commercially available. The thickness of the outer functional layer 11 is up to approximately 100 microns near side 18, corresponding to the root of the tooth, and up to approximately 500 microns at side 16, corresponding to the tip of the tooth. The thickness of the outer functional layer 11 may be substantially increased when desired for cosmetic purposes, as will be discussed further herein. Correspondingly, the thickness of the inner functional layer 13 is between approximately 300 to 400 microns at the root, and approximately 50 to 100 microns at the tip. Of course, the precise thickness of each layer may vary based on the tolerances of the machines and materials that are used to manufacture the layers. The ranges provided here are to be understood as being subject to such tolerances. Advantageously, the thick inner functional layer 13 at the root allows for flexing of the aligner 10 as the aligner 10 is placed over the teeth, thus enabling proper placement of the aligner. In addition, the elastomeric layer 13 is molded to fit the teeth with sufficient tightness to function as a gasket, preventing entry of food particles between the teeth and the orthodontic aligner 10. The thicker outer functional layer 11 provides compressive force as well at the base of the teeth, contributing to the closure of the gasket. This gasket functions by applying force around the entire perimeter of the teeth, without applying force on the gums. The combination of the outer functional layer 11 and inner functional layer 13 thus provides a more effective seal than a corresponding aligner made of a single material. In addition, the thicker outer layer 11 at the tip of the teeth enables the aligner 10 to withstand the high pressures of eating. Simultaneously, the elastomeric inner functional layer 13 serves as a shock absorbent during chewing and bruxism (grinding of the teeth).

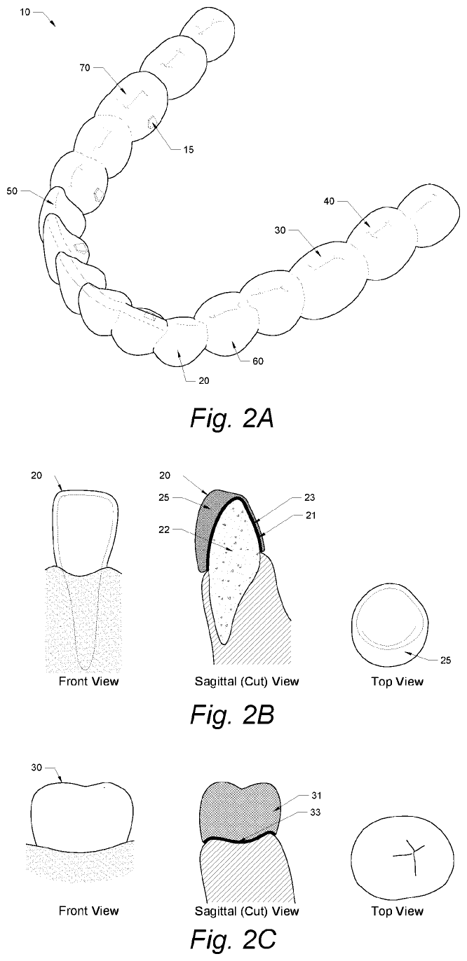

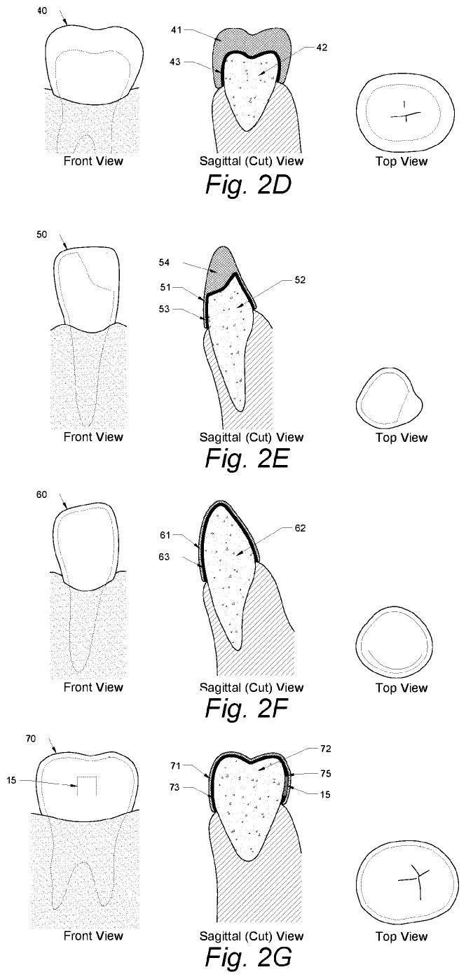

FIG. 2A depicts aligner 10 with various sections 20, 30, 40, 50, 60, 70 overlaying teeth with different deformities or treatments. Each of these teeth is illustrated in greater depth in FIGS. 2B-2G. Generally, the aligner has one or more regions of increased thickness corresponding to a region of decreased thickness of a corresponding tooth or arch point or region. These regions of decreased thickness may have different manifestations, and, correspondingly, the regions of increased thickness may have different shapes, as will be described below.

FIG. 2B depicts the appearance of the aligner section 20 on a crooked tooth 22. As seen on the left, the front view of the tooth with aligner section 20 thereon is similar to that of a standard tooth. The central view of FIG. 2B illustrates a sagittal cross-section of the tooth 22 and aligner section 20. The aligner section 20 includes elastomeric functional layer 21 and rigid functional layer 23. A thickened section 25 of the rigid functional layer 23 forms a veneer at the top of the tooth 22, to compensate for the crookedness of the tooth 22, so that the tooth 22 appears with a desired or preferred tooth shape. The right side of FIG. 2B shows a top view of the aligner section 20 when worn over the tooth. The thickness of the rigid outer functional layer at this occlusal face may be approximately 400 μm, as discussed above, but may be additionally up to as much as 8,000 μm in the thickened section, or even greater, depending on the occlusal gap. This is in contrast to the typical thickness of the aligner without compensation for crooked teeth, which is in the vicinity of up to 800 μm for the combination of the functional layers, as discussed.

FIG. 2C depicts the appearance of aligner section 30 on a space corresponding to a missing tooth. As seen on the left side of FIG. 2C, the buccal view of the aligner section 30 has the appearance of a regular tooth. The central part of FIG. 2C is a cross section of aligner section 30. The aligner section 30 includes only a thin elastomeric layer 33 near the gingival line, with the entire rest of the aligner section 30 being entirely the rigid layer 31. The right side of FIG. 2C shows a top view of aligner section 30, which appears identical to that of a regular tooth.

FIG. 2D illustrates an aligner section 40 for a tooth 42 that is too small, and which needs to be built up in all directions. As seen on the left side of FIG. 2D, the buccal view of the aligner section 40 has the appearance of a regular tooth. The central part of FIG. 2D is a cross section of aligner section 40. The elastomeric layer 43 surrounds the tooth 42 with a thickness of approximately 200-300 μm near the root and 50-100 μm near the tip. The rigid section 43 is built up relative to a standard aligner section, reaching a thickness of approximately 400 μm near the root and up to 1,000 μm height, or even higher, at the tip. As seen at the right of FIG. 2D, the top view of section 40 is the same as that of a conventional tooth.

FIG. 2E depicts an aligner section 50 over a tooth 52 that is chipped. As seen at the left of FIG. 2E, the front view of aligner section 50 is identical to that of a standard tooth. The central view of FIG. 2E depicts a cross section of aligner section 50. Rigid functional layer 51 and elastomeric functional layer 53 encase the tooth 52, as with a standard tooth; however, rigid functional layer 51 includes a thickened portion 54 that fills in the missing part of the tooth. As seen at the right of FIG. 2E, the top view of section 50 is the same as that of a conventional tooth.

FIG. 2F depicts an aligner section 60 over a conventional tooth 62. A front view is shown at the left, a cross-section view shown at the center, and a top view is shown at the right. The thicknesses of rigid functional layer 61 and elastomeric functional layer 63 are standard.

FIG. 2G depicts an aligner section 70 over a tooth 72 that has a lingual button 15. As seen at the left of FIG. 2G, the front view of the aligner is identical to that of a standard tooth. Advantageously, because the button 15 is on the lingual side, there is no indication whatsoever of the presence of button 15. The central view of FIG. 2G illustrates a cross-section view of the tooth 72 and the aligner section 70. Rigid functional layer 71 and elastomeric functional layer 73 have standard thicknesses throughout, except that elastomeric layer 73 has a secondary cavity 75 to make space for the button 15. The indentation 75 may also cause the rigid layer 71 to jut outwards.

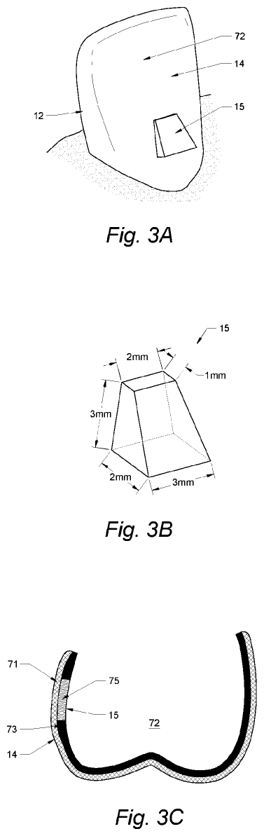

FIGS. 3A-3C depict the lingual button 15 in further detail. As seen in FIG. 3A, button 15 is positioned on the lingual side 14 of a tooth 72. FIG. 3B illustrates one possible shape for the button 15, with a triangular cross section, and including optional dimensions of length, width, and height. The button 15 may alternatively have any other shape suitable for orthodontic treatment, including but not limited to, for example, star, square, or rectangle, or irregular shapes. FIG. 3C is a cross-section view showing the lingual button 15 on the tooth 72, and the aligner placed over the tooth 72 and button 15, as in FIG. 2G.

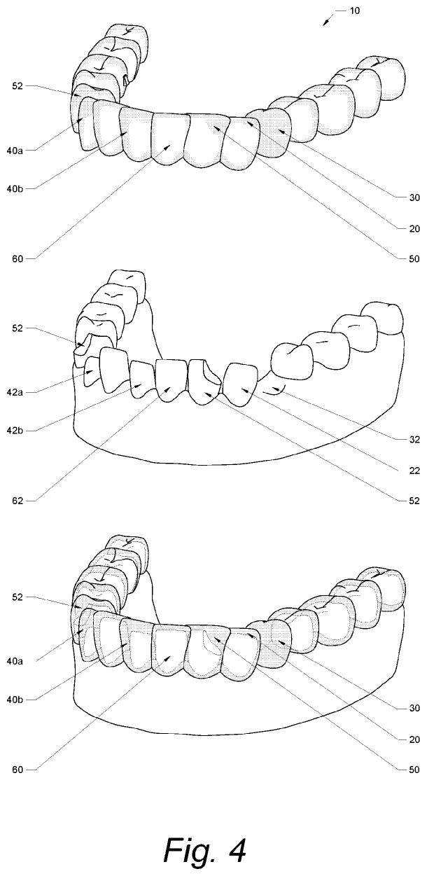

FIG. 4 illustrates how different regions of the aligner 10 may be built up differently and used to cover uneven tooth surfaces, in order to create a uniform appearance for the teeth. As shown at the center of FIG. 4, the array of teeth includes teeth with various defects, including crooked tooth 22, missing tooth 32, small teeth 42a and 42b, chipped tooth 52, and standard tooth 62. Teeth with buttons are also present but are not specifically indicated. The aligner 10 is built up in regions corresponding to the deficiencies in each of the teeth. Thus, sections 40a and 40b have a veneer on the labial side of the aligner; section 30 is nearly entirely of rigid material to fill in the missing tooth 32; region 20 is built up to smooth out the crooked tooth 22, region 50 is filled in at one spot to cover a defect in a chipped tooth, and region 60 has a standard configuration.

As discussed above, aligner 10 may be used for implementation of various orthodontic treatments, including orthodontic treatments that are not feasible with currently available clear aligners.

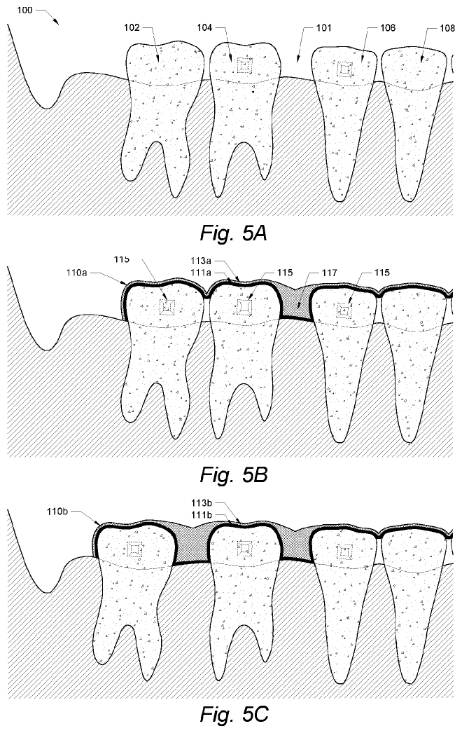

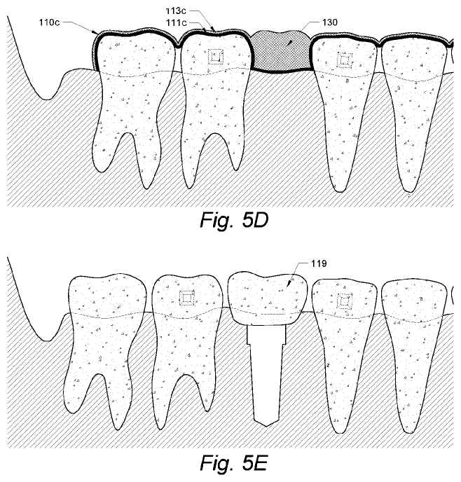

FIGS. 5A-SD illustrate use of the aligner 10 for performing distalization. Referring to FIG. 5A, an array of teeth includes molars 102, 104 and bicuspids 106, 108. A space 101 is present between molar 104 and bicuspid 106, for which the desired treatment is inserting an implant. However, in the configuration of FIG. 5A, there is not enough space to insert an implant.

The solution is to distalize the molars using a series of aligners 110a, 110b, 110c, as shown in FIGS. 5B-5D. Referring first to FIG. 5B, aligner 110a includes elastomeric layer 111a and rigid layer 113a. The aligner 110a exerts forces on buttons 115. Aligner 110a further includes a built-up section of rigid material 117 that fills interproximal space 101. Rigid material 117 exerts force in conjunction with the buttons 115, thereby increasing the gap between teeth 104 and 106. During this treatment, teeth 102 and 104, and teeth 106 and 108, are anchored relative to each other. In the view of FIG. 5C, a different aligner 110b is utilized. This aligner 110b includes a bridge pontic 130 made of the rigid material, similar to aligner region 30 of FIG. 2C. This bridge pontic 130 provides further separating force between teeth 104, 106. The pontic 130 is comprised of a material of the outer functional layer over an entire dimension of the pontic, and includes the material of the elastomeric inner layer at the gingival margin. Unlike many pontics which are implemented solely for cosmetic purposes and cannot be used while eating, the material of the pontic, according to the present disclosure, enables maintaining of the pontic in place during eating. The placement of the inner elastomeric material at the gingival margin serves concerns of both hygiene and comfort. In FIG. 5D, the teeth are sufficiently separated so that an implant 119 may be implanted.

In another possible implementation, the aligner 10 may be used for sequential distalization of the upper or lower molars and bicuspids. Similar to the stages shown in FIGS. 5A-5D, sequential distalization also proceeds in stages. Each stage operates by anchoring all of the teeth minus the one or ones being isolated for distalization, in sequence. This is achieved by increasing the size of the rigid layer in the interproximal spaces, thus effectively increasing the tooth size, and then reducing the size of the rigid layer in a sequential order. Advantageously, this technique may save healthy teeth from being removed close to a deformity of bimaxillary protrusion. In addition, these techniques may be applied equally to upper and lower teeth, unlike certain approaches for sequential distalization, such as headgear, which are effective only on the upper teeth.

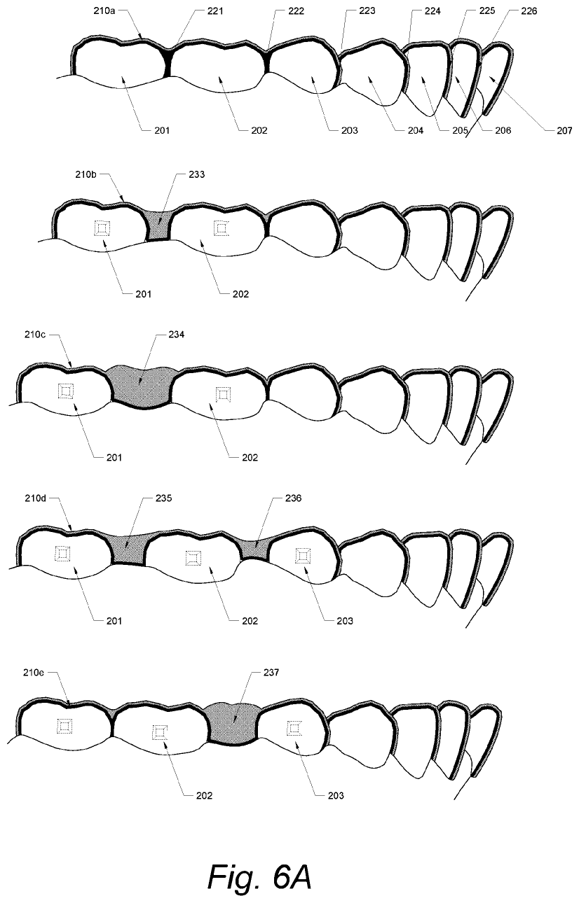

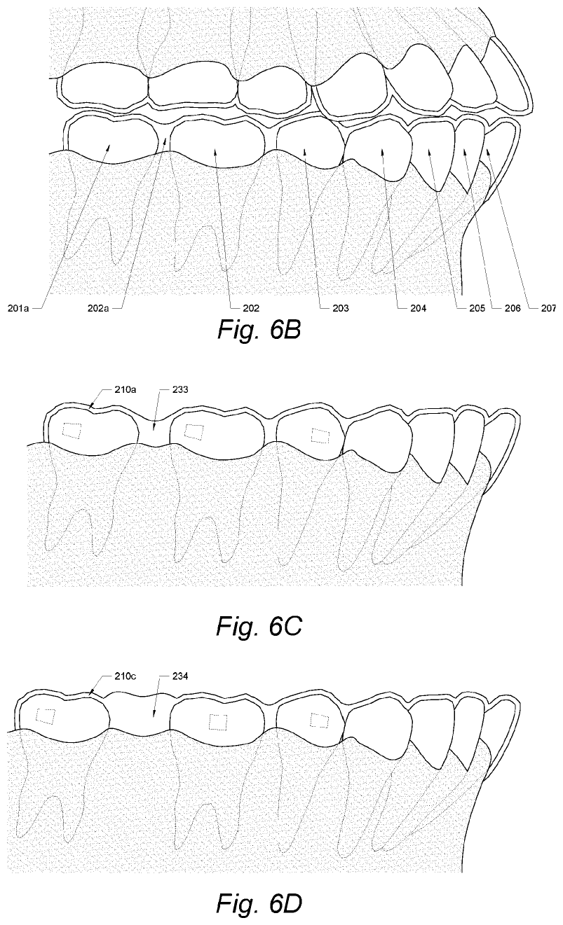

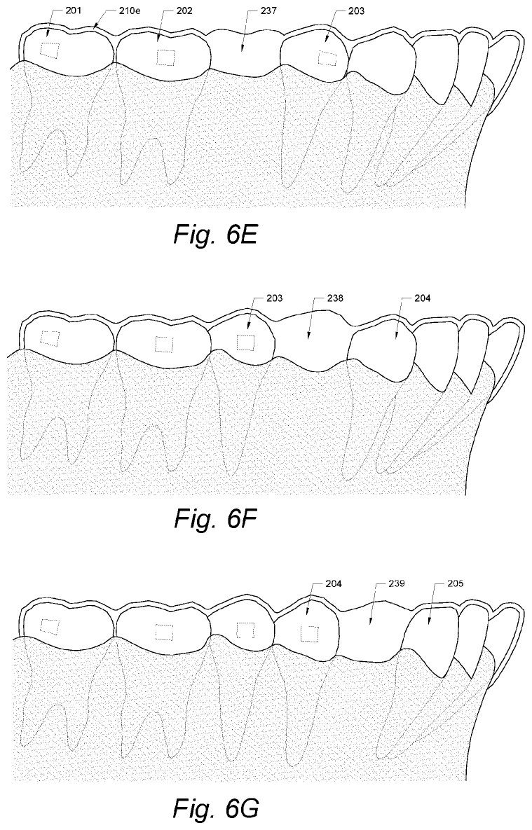

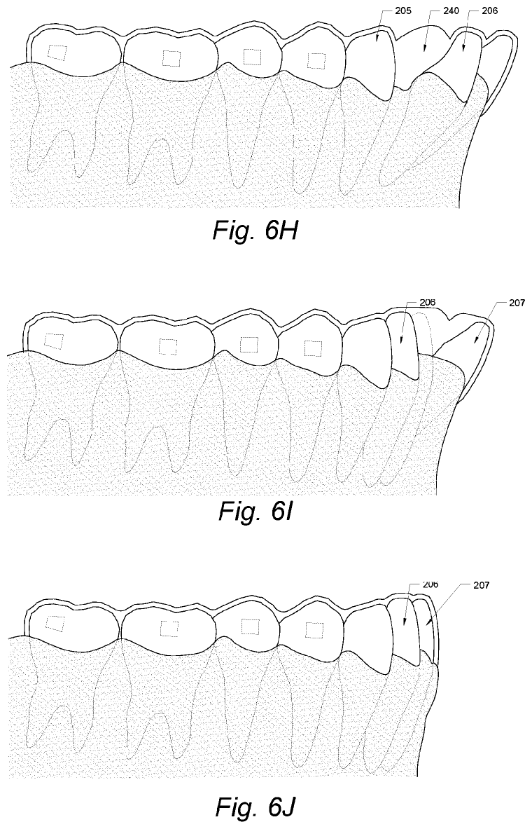

An exemplary implementation of sequential distalization is shown in FIGS. 6A-6J. FIG. 6A illustrates a lower arch in a state of bimaxillary protrusion. The lower arch includes teeth 201, 202, 203, 204, 205, 206, and 207, and interproximal gaps 221, 222, 223, 224, 225, and 226. The first stage of treatment is shown at the top of FIG. 6A and in FIG. 6B. An aligner 210a is fitted over the lower arch. The aligner includes an clastic material functional layer in between certain of the teeth, including elastic functional layer 231 within interproximal gap 221. The elastic functional layer 231 is used to provide initial separation between the teeth while preserving patient comfort.

The elastic functional layer 231 widens interproximal gap 221 by moving tooth 201 leftward. This is shown in the middle section of FIG. 6A as well as in FIG. 6C. In order to ensure that tooth 201 moves, in the desired direction, the other teeth may be anchored to each other.

At the next stage of the treatment, as interproximal gap 221 increases, aligner 210b includes clastic functional layer 232 as well as rigid functional layer 233. Eventually, the gap is sufficient to fit nearly an entire tooth, and aligner 210c is introduced with thickened rigid layer 234 to complete the widening at gap 221. This state is also shown at FIG. 6D. Aligner 210d is then introduced, with a thickened rigid region 236 for moving tooth 202 into the space vacated by tooth 201, and a correspondingly smaller rigid region 235 for filling the interproximal space between teeth 201 and 202. At the bottom of FIG. 6A, as well as in FIG. 6E, teeth 201 and 202 are adjacent to each other, and the interproximal region between teeth 202 and 203 is filled by thickened region 237 of aligner 210e. The same steps are repeated sequentially, so that the teeth eventually reach the positions of FIG. 6F (thickened region 238 between teeth 203 and 204}; FIG. 6G (thickened region 239 between teeth 204 and 205); and FIG. 6H (thickened region 240 between teeth 205 and 206). At this point, there is enough space in the mouth to distalize and straighten teeth 206 and 207, as shown in FIG. 6I, leading to the final positioning of the teeth as shown in FIG. 6J.

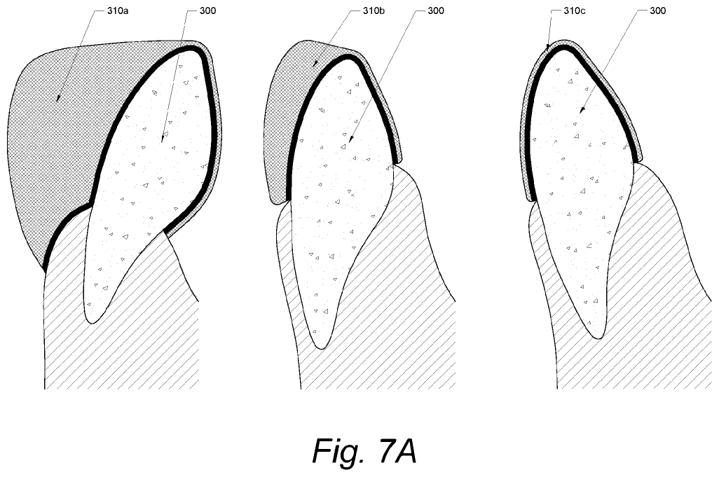

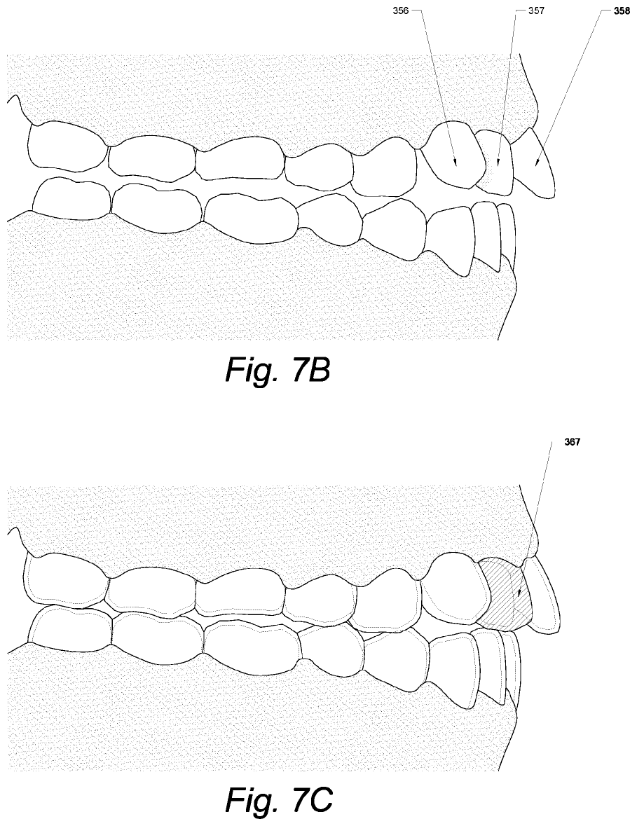

FIGS. 7A-7C illustrate another exemplary use of the aligner system described herein, particularly in the context of erupted teeth. Referring to FIG. 7A, on the left side, tooth 300 is erupted in the lingual direction. It is possible to approximate an even smile by adding a substantial layer of rigid material onto the front of the aligner section 310a overlaying that tooth, on the labial side of the aligner. As treatment progresses and the tooth straightens, the aligner may be replaced with a new aligner with section 310b having a thinner layer of rigid material, until the tooth is completely straight and the aligner section 310c appears similar to that of a conventional aligner section.

In the view of FIG. 7B, erupted teeth 356 and 358 jet forward, toward the labial side of the teeth. As a result, the treatment described above is not available. Accordingly, one solution is to coat adjacent tooth 357 with thickened rigid portion 367, so as to give the appearance of an even surface between teeth 356, 357, and 358. FIG. 7C illustrates the thickened rigid portion 367 creating the appearance of a straight arch. When the deviation between teeth 356, 357, and 358 is too great to enable even this treatment in an aesthetically-pleasing manner, the aesthetic treatment may be forgone until tooth 307 is partially straightened.

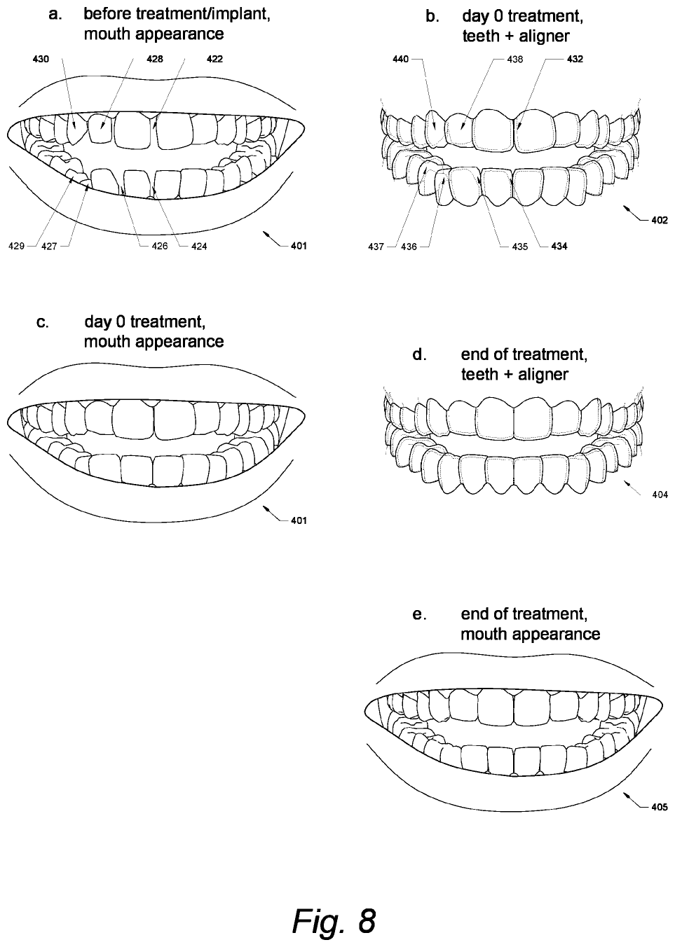

FIGS. 8-10 depict other examples of treatment with the aligners according to the present disclosure, and in particular illustrate how the aligners may achieve an aesthetic solution in conjunction while simultaneously moving the teeth. In general, the primary function of the aligners is to align the teeth into an ideal position. When the teeth are in the ideal position, the phase of the treatment involving the aligners is complete. During the stage of orthodontic treatment using the aligners, the aligners are formed with a veneer that is thicker in or at the interproximal spaces, as well as in the labial and buccal and occlusal directions, where relevant, according to the aesthetic and orthodontic goals of the treatment. The veneer creates the appearance of a more finished look. Following treatment with the aligners, the patient will look like he or she has completed treatment when he or she is wearing the aligner, but may have some gaps when the aligner is removed. To address these lingering gaps, additional solutions such as permanent veneers, caps, crowns, or implants may be implemented into the patient's final orthodontic treatment plan.

FIG. 8 shows a crooked smile with central diastemas 422, 424, 426 (gap between the teeth) and peg laterals 427, 428, 429, 430 (incisors are abnormally small and pointy). Step 401 shows the smile prior to treatment. Step 402 shows the smile at the outset of treatment, with upper aligner 410a and lower aligner 410b fitted thereon. Upper aligner 410 includes sections 432, 438, and 440 with built-up rigid layers serving as a veneer, to fill in the respective gaps left by the peg lateral teeth and by the diastema in the upper teeth. Similarly, lower aligner 410b includes sections 434, 435, 436, 437 that fill in the gaps left by the diastemas and peg lateral teeth. As a result, the appearance of the mouth with the aligners inserted on the first day of treatment, as shown in stage 403, is very nearly identical to the appearance of the mouth and aligners on the last day of treatment, as shown in stage 404, and to the appearance of the mouth itself on the last day of treatment, as shown in stage 405. The view of the mouth in stage 405 may include veneers to compensate for the reduced size of the peg lateral teeth.

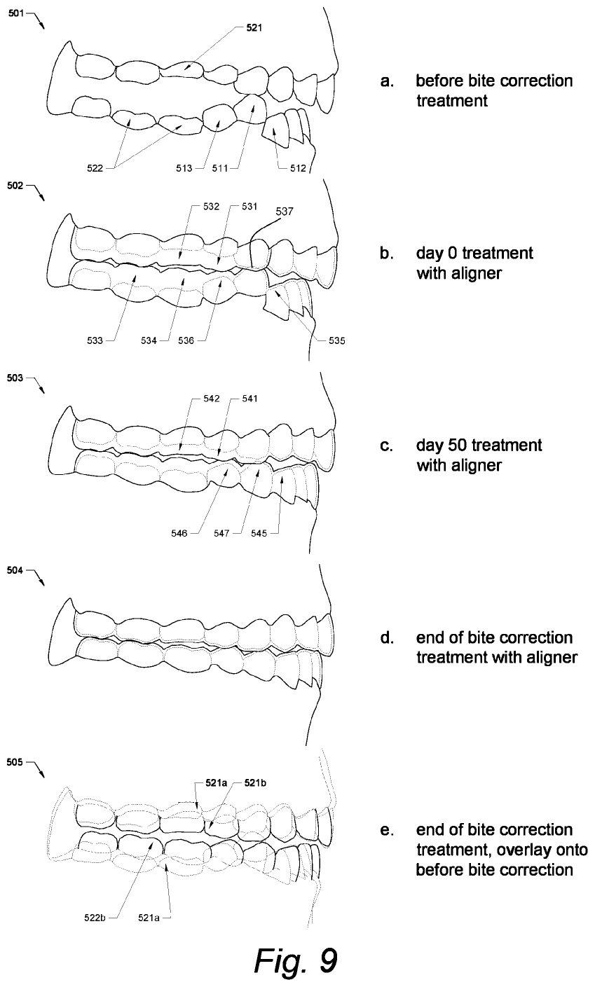

FIG. 9 illustrates use of aligners for treatment of malocclusion of teeth. Stage 501 illustrates a sagittal profile view of the initial positioning of the teeth, with the molars of upper teeth 521 and lower teeth 522 not meeting at all. In addition, the lower teeth 521 include an erupted tooth 511. Tooth 511 is in traumatic occlusion. At stage 502, the upper aligner is fitted with additional thickness at sections 531 and 532, and the lower aligner is fitted with corresponding additional thickness at sections 533, 534, so as to bring the gaps of the maloccluded teeth closer together, thus distributing the bite force and preventing traumatic occlusion while eating. Simultaneously, section 537 is fit over the raised tooth, and sections 535 and 536 are fit around the surrounding teeth. These sections operate to increase the space between teeth 512 and 513 and to lower tooth 511 into the vacated space. At stage 503, the teeth are shown in an intermediate stage of treatment. Aligner sections 541, 542 continue to have additional thickness in order to bring the molars together, and aligner sections 545, 546, and 547 continue to operate to create a space for the raised tooth and to lower the raised tooth. At stage 504, the bite correction treatment is complete, with all the teeth properly aligned, and the aligners having approximately the same configuration as the teeth themselves. Stage 505 schematically shows the approximate final positioning of upper teeth 521b and lower teeth 522b overlaid on the initial positioning of upper teeth 521a and lower teeth 522a.

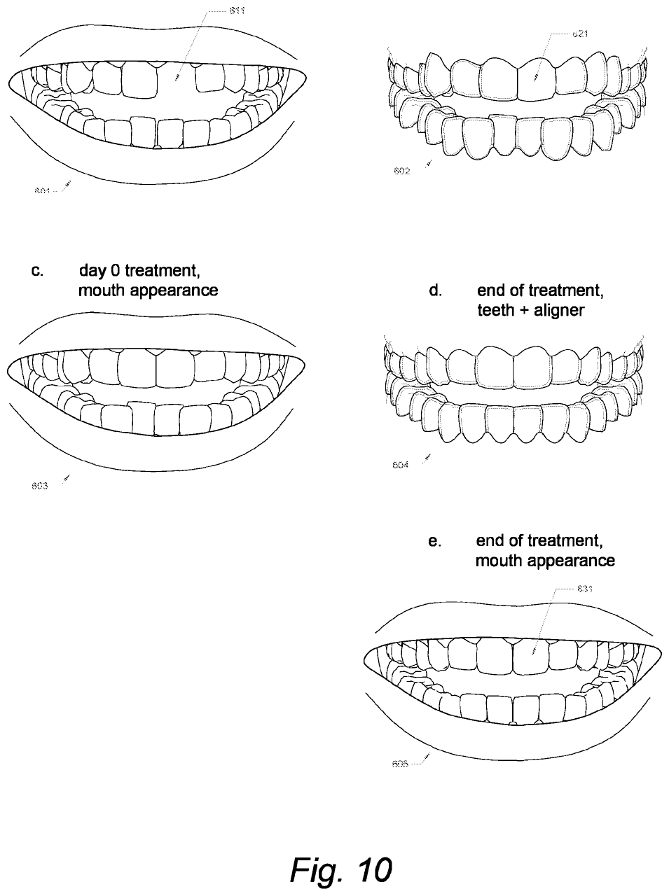

FIG. 10 illustrates the use of the aligner to simultaneously straighten the teeth and fill in a missing tooth. At step 601, the appearance of the mouth is shown before treatment, including missing tooth 611. At step 602, aligners are placed onto the teeth, with the upper aligner including a pontic 621 comprised nearly entirely of the rigid layer, with the elastomeric layer at the gingival margin, as discussed above. As a result, the view of the teeth at the start of the treatment and with the aligner, as shown in stage 603, and at the end of the treatment and with the aligner, as shown in stage 604, is identical. Stage 605 illustrates the appearance of the mouth following completion of treatment, with a permanent implant 631 filling the space of the missing tooth.

Following completion of the movement of the teeth with the aligners, a final tray may be prepared and worn as needed or at night to maintain positioning of the teeth.

The aligners described above may be combined with various other orthodontic treatments. For example, although, for standard treatments, the aligners end at the gingival margin, the aligners (particularly, the rigid layers of the aligners) may alternatively extend to and over the hard palate. The palate extension may serve for pediatric patients as an alternative to a palate expander for dentofacial orthopedics. In addition, the palate extension may serve as a further support to which a traditional denture may be affixed. The palate extension may be made of a different material than the rigid outer layer and elastomeric inner layer. For example, the palate extension may be made of a semi-flexible or hard acrylic. The palate extension may also be made of the same material as the rigid outer layer or the elastomeric inner layer. The composition of the palate extension may be selected on a case-by-case basis, depending on how much flexibility and force is needed in the palate region. Correspondingly, the aligners may also extend over the anterior face of the maxilla. This additional coverage on the maxilla is beneficial when the aligners are used as partial dentures. In situations when multiple teeth are missing, the aligner may need support in order to stay in place. The additional coverage on the maxilla and/or palate provides this support.

As another example of an add-on component, metal rings or snap buttons for the molars may also be fabricated with the aligner. The rings or snap buttons are used for palate expansion or anchorage or other dental procedures. The metal rings may be affixed with temporary cement as used in a fixed palate expander, and may be changed as needed with the entirety of the aligner. The aligner may also be installed with one or more sets of magnets, in order to enable a magnetic attraction to, or a magnetic repulsion from, additional sets of magnets located in the mouth, for example attached to the teeth. A silicone like glue and/or bonding material composites may also be used to further seal the space between the elastomeric layer and enamel of the teeth, to reduce the risk of caries. This glue or bonding material is preferably semi-flexible, to allow for easy removal of the aligner by the orthodontist.

Optionally, purely aesthetic additions may also be implemented. For example, a temporary grill may be applied, in which studding and specialized hues may be applied. The labial grill attachments may be glued, magnetized, or fixed in various ways. The attachments may then be reapplied to future trays. Other less common aesthetic changes, such as creating a fake gap, or fake “buck” teeth, may also be implemented via various thicknesses and hues of the appliance. Such aesthetic changes may be desirable, for example, during orthodontic treatment of actors.

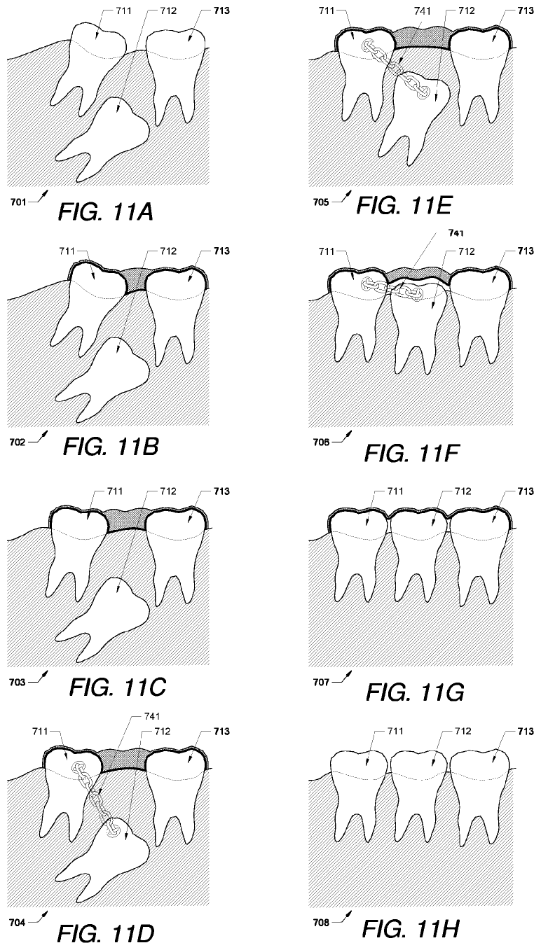

FIGS. 11A-11H illustrate how the aligner may be used to treat impacted or unerupted teeth. In traditional orthodontics, when a tooth is viable but impacted, the tooth is exposed through surgical intervention. An oral surgeon attaches a bracket and chain to the unerupted tooth, below the gum line. An orthodontist then attaches the other end of the chain to wire of the braces, or to an adjacent tooth with a bracket. This method of treatment is currently unavailable with clear aligners. In addition, typically, the gap between the erupted teeth is not wide enough to permit insertion of a pontic. Thus, the only available methods of treatment do not permit for aesthetic compensation. The aligners of the present disclosure address this, by enabling sequential inclusion of sections of different materials and thicknesses. These intervening sections distalize the teeth, and, eventually, serve as a bridge pontic. The pontic functions as a bite block, to even out the occlusion and prevent undesirable consequences as the tooth erupts.

Referring to FIG. 11A, at initial stage 701, impacted tooth 712 is below and between teeth 711 and 713. In FIG. 11B, at stage 702, an aligner is placed over teeth 711 and 713. The aligner includes an elastomeric functional layer near the teeth. The elastomeric functional layer also fills the gap between teeth 711 and 713. This elastomeric functional layer is a spacer that also distalizes teeth 711 and 713, until the gap between them is larger, as illustrated at stage 703 in FIG. 11C. In FIG. 11C, the space between the teeth 711 and 712 is larger, permitting the space to be filled by the more rigid functional layer, which further contributes to the distalization of the teeth and also functions as a bite block until tooth 712 is raised. Referring to FIG. 11D, at stage 704, the oral surgeon attaches a chain 741 to teeth 711 and 712. Alternatively, the chain may be attached to the portion of the aligner that covers tooth 711. The method of attachment of the chain may be in accordance with any method known to those of skill in the art. In FIG. 11E, at stage 705, the rigid layer of the aligner continues to operate to distalize teeth 711 and 712, while chain 741 begins to raise impacted tooth 712. In FIG. 11F, at stage 706, the impacted tooth is nearly between teeth 711 and 713. The chain 741 is accordingly shortened. In FIG. 11G, at stage 707, the impacted tooth is raised to its place between teeth 711 and 713. The rigid functional layer is no longer needed to serve as a bridge pontic. Hence, the rigid layer is reduced in size, or replaced with an elastomeric layer, such that the aligner is of approximately identical thickness across all of the teeth. In FIG. 11H, at stage 708, the treatment is complete and the aligner is removed.

A process for manufacture of the multilayer aligners begins with the orthodontist taking an impression or 3d scan of the patient's teeth, in a manner known to those of skill in the art. The impression or scan is converted into a 3d model of the patient's bite in relevant software.

The orthodontist determines a plan for how he or she wishes for the teeth to move. Software may generate a video model showing how an aligner is expected to affect the positioning of the teeth over time. The practitioner confirms that the expected teeth movement is consistent with clinical goals. In addition, the practitioner may use the software to prepare a digital model of the cosmetic improvements he or she desires for the teeth. The cosmetic improvements may include factors such as hues, thickened layers, veneers, coatings, or pontics. Alternatively, software may be equipped with Al technology for recommending to the practitioner the ideal outer and inner proportions of the rigid layer for motion, gripping, and aesthetics. As discussed above, as a result of the addition of the aligners, various teeth are built-up in a veneer-like fashion, or even completely “repositioned” via the illusion of the aligner. Internally, underneath the aligner, the teeth move to approach the appearance of the outer rigid layer.

Following completion of the design, the aligner is manufactured. In a preferred embodiment, the aligner is manufactured in an additive manufacturing process. When the aligner is made of different materials, the additive manufacturing process may be performed using a multi-material 3D printing device. An exemplary multi-material additive manufacturing 3D printing device available today is the Polyjet™ sold by Stratasys, Inc. Other manufacturing techniques are possible, such as hand-forming, gluing, milling, and injection molding.

In one manufacturing approach, the elastomeric inner functional layer and the rigid outer functional layer are manufactured together in the same 3D printing device. Depending on the materials, the 3D printing may be performed through use of a CAD program, for printing on a surface. The layers may optionally be printed over a mold, such as a wax mold, where relevant for the materials. The elastomeric inner layer is then fabricated, and the rigid outer layer is fabricated. These layers may be formed substantially simultaneously or sequentially. The rigid outer layer may be attached to the elastomeric inner layer through any appropriate means, such as gluing, sintering, or curing, depending on the composition of each layer. The minimum thickness of each layer is dictated by the capabilities of the 3d printing device, which currently is approximately 15 μm. The maximum thickness may be up to approximately 8,000 μm or even thicker, as dictated by the cosmetic needs, as discussed above. When deemed necessary, the layers may also be hand-milled and/or hand-affixed.

In an alternative embodiment, the elastomeric inner functional layer and outer functional layer are manufactured separately. The inner functional layer is secured directly to the patient's teeth and gums. This securing may be accomplished through any suitable process, including reliance on the inherent elasticity of the elastomeric layer (e.g., through an interference fit}, or using an adhesive, bands, or magnets. Once the inner functional layer is in place, the outer functional layer is then overlaid onto the inner functional layer, like a shoe over a sock. Separating the manufacturing process is of particular value when the inner functional layer and outer functional layer are made of two different materials that are not easily manufactured together in the same process, such as an elastomer and a ceramic, which require different curing processes.

Should the patient require additional features that require metal sintering that cannot be directly fabricated, the individual additional parts may be fabricated individually. The individual parts may then be attached to the aligner at the point of manufacture, or may be glued to the aligner by the orthodontist, as desired. For example, a grill may be attached to the aligner in a similar manner.

When a final tray (e.g., a retainer} is used, the final tray may be pre-fabricated based on the final estimate of the veneer and crown adjustments of the teeth, taken at the outset of treatment. The final tray may thus serve as a preview for the permanent and semi-permanent final appearance of the teeth. Alternatively the patient can get a final scan upon completion of the treatment, and the final tray may be manufactured following that scan. In the latter case, care should be taken to have the final tray ready as close as possible to cessation of treatment with the aligners, so as to prevent movement of the teeth.

1. An orthodontic aligner, comprising:
an inner functional layer comprised of an elastomer; and a non-elastomeric outer functional layer.

2. The orthodontic aligner of claim 1, wherein the outer layer is comprised of a biocompatible rigid or semi-rigid polymer.

3. The orthodontic aligner of claim 1, wherein the inner functional layer and outer functional layer are made of a functionally graded material.

4. The orthodontic aligner of claim 3, wherein the functionally graded material is a functionally graded polymer having greater elasticity at the inner functional layer and greater rigidity at the outer functional layer.

5. The orthodontic aligner of claim 1, further comprising a plurality of inner cavities within the inner layer, each inner cavity shaped to receive therein a tooth attachment.

6. The orthodontic aligner of claim 5, wherein the inner cavities are configured to receive therein lingual tooth attachments.

7. The orthodontic aligner of claim 1, wherein the elastomeric inner functional layer is molded to fit a tooth with sufficient tightness to function as a gasket preventing entry of food particles between the tooth and the orthodontic aligner.

8. The orthodontic aligner of claim 1, wherein a combined thickness of the outer and inner functional layers is up to 800 μm in a region surrounding at least one tooth.

9. The orthodontic aligner of claim 8, wherein a thickness of the outer functional layer in said region is up to approximately 100 microns at a region corresponding to a root of a tooth, and up to approximately 500 microns at a region corresponding to a tip of the tooth, and a thickness of the inner functional layer is between approximately 300 to 400 microns at the root, and between approximately 50 to 100 microns at the tip.

10. The orthodontic aligner of claim 1, wherein the aligner maintains structural integrity at temperatures of between approximately −3° C. to 105° C.

11. The orthodontic aligner of claim 1, wherein the aligner maintains structural integrity at pressures of up to approximately 800 psi.

12. The orthodontic aligner of claim 1, further comprising at least one region of increased thickness on an external face of the outer functional layer, said region of increased thickness corresponding to a region of decreased thickness of a corresponding tooth or arch point.

13. The orthodontic aligner of claim 12, wherein the region of increased thickness has a thickness of up to approximately 8,000 μm.

14. The orthodontic aligner of claim 1, further comprising at least one pontic, wherein the pontic is comprised of a material of the outer functional layer over an entire dimension of the pontic and includes the material of the inner functional layer at a gingival margin.

15. The orthodontic aligner of claim 1, further comprising an extended portion configured to extend over a hard palate of a patient, said extended portion comprised of the material of the outer functional layer, the material of the inner functional layer, a semi-flexible acrylic, or a hard acrylic.

16. The orthodontic aligner of claim 1, wherein the outer layer is comprised of regions having various thicknesses so as to form a veneer and thereby smooth out an appearance of adjacent teeth.

17. The orthodontic aligner of claim 16, wherein the regions of various thicknesses include at least one of additional thickness at the tip of a tooth and additional thickness in an interproximal space between two teeth.

18. A system for orthodontic treatment, comprising:
the orthodontic aligner of claim 1; and
one or more aligner attachments configured for attachment onto a patient's teeth.

19. The system of claim 18, further comprising metal rings or snap buttons for affixation onto molars.

20. The system of claim 18, further comprising a plurality of magnets, including a first set of magnets for affixation onto teeth and a second set of magnets for affixation onto the aligner.

21. The system of claim 18, further comprising a temporary grill applied over the outer functional layer.

22. The system of claim 18, further comprising at least one chain for raising and exposing an impacted tooth.

23. A method of orthodontic treatment, comprising:
affixing an orthodontic aligner to the teeth, said orthodontic aligner including an inner functional layer comprised of an elastomer and a non-elastomeric outer functional layer.

24. The method of claim 23, wherein the orthodontic aligner includes a plurality of inner cavities within the inner layer, each inner cavity shaped to receive therein an aligner attachment, and the method further comprises applying aligner attachments to a plurality of teeth; and wherein the affixing step comprises overlaying the inner cavities over the aligner attachments.

25. The method of claim 24, wherein the step of applying aligner attachments comprises applying the attachments to a lingual side of the teeth.

26. The method of claim 24, wherein the orthodontic aligner comprises at least one interproximal section, said interproximal section being configured to apply an interproximal force, and the method further comprises performing distalization with the at least one interproximal section.

27. The method of claim 26, further comprising performing sequential molar distalization with a series of orthodontic aligners each having different sections of increased thickness.

28. The method of claim 27, wherein the at least one interproximal section of a first aligner of the series is comprised of the elastomeric functional layer functioning as a spacer, and the at least one interproximal section of a subsequent aligner of the series is comprised of material of the both the elastomeric functional layer and the outer functional layer.

29. The method of claim 24, wherein the orthodontic aligner further comprises a chain, and the method further comprises affixing the chain to an impacted tooth and raising the impacted tooth to a space opened through the performance of the distalization.

30. The method of claim 24, wherein the step of affixing the orthodontic aligner to the teeth comprises first affixing the inner functional layer and subsequently overlaying the outer functional layer onto the inner functional layer.

31. The method of claim 24, wherein the step of affixing the orthodontic aligner to the teeth comprises affixing the aligner to the teeth when the outer functional layer is already adhered to the inner functional layer.
